(19) United States
(12) Patent Application Publication
(10) Pub. No.: US 2009/0223068 A1
(43) Pub. Date: Sep. 10, 2009

(54) Rotary cutter

(76) Inventors: Ravi Kumar Sawhney, Calabasas, CA (US); Kurt Gregory Botsai, Thousand Oaks, CA (US); Christopher Warren Glupker, North Hills, CA (US); Toshihiro Aya, Reseda, CA (US); Leah Louise Thomas, Burbank, CA (US); John Mark Vernon, Malibu, CA (US)

Correspondence Address: BRINKS HOFER GILSON & LIONE, P.O. BOX 10395, CHICAGO, IL, 60610, US

(21) Appl. No.: 12/074,859

(22) Filed: Mar. 5, 2008

(51) Int. Cl. B26B 25/00; B26D 3/00

(52) U.S. Cl. 30/319; 83/56

(57) ABSTRACT

A pizza cutter is provided. In one implementation, the pizza cutter may include a handle, an arm coupled to an end of the handle, a circular blade coupled to the arm; and a crust cutter member coupled to the end of the handle. An edge of the crust cutter member may be sharpened. The crust cutter member may extend in a plane that may be substantially parallel to a centerline of the handle. The pizza cutter may also include a second crust cutter member coupled to the end of the handle. The second crust cutter member may also have sharpened edge. The second crust cutter may extend in a perpendicular direction relative to the crust cutter member above, in a plane that may be substantially parallel to the centerline of the handle.

### BACKGROUND

The field of the invention relates to food cutting instruments. In particular, the invention relates to a rotary cutter for cutting pizzas.

Rotary Cutters are utilized for slicing food items, such as pizzas into smaller portions. Food items, such as pizzas, come in many forms. For example, a pizza may have a thin crust or thick crust. The pizza may be served in a pan. Some pizzas are “stuffed” in that there may be a crust above and below the main ingredients. Some pizzas may also include a crust wall along the perimeter of the pizza.

A variety of cutters exist that allow a pizza server to slice a pizza into sections or serving portions. These pizza cutters may comprise a handle and a blade. For example, one type of pizza cutter may include a semi-circular blade portion with handles on both sides of the straight portion of the blade for applying a downward force in conjunction with a rocking motion to cut the pizza. In other configurations, the pizza cutter may be comprised of a handle and a rotating circular blade attached in such a way as to enable a pizza server to roll the pizza cutter across the pizza.

At least one disadvantage of the pizza cutters described above is that they may not be well suited at thoroughly cutting the crust wall of a pan pizza while the pizza is still in the pan. For example, the semi-circular pizza cutter described above may not be capable of completely cutting through the corner portion because the edges of the pan may be in the way. To cut that portion of the crust with a circular blade pizza cutter a pizza server may have to apply extra pressure against the crust. In do so, the crust may not break cleanly. In addition, the extra force applied may result in premature dulling of the circular blade, as the circular blade will likely hit the pan upon piercing the crust. Furthermore, the circular blade may not be able to cut completely through the edge of the crust on a raised-edge pan because the radius of the circular blade may be significantly larger than the cross sectional radius between the pan wall and the bottom of the pan.

### SUMMARY OF THE INVENTION

To address the problems identified above, a pizza cutter is provided. The pizza cutter may include a handle, an arm coupled to an end of the handle, a circular blade coupled to the arm; and a crust cutter member coupled to the end of the handle. An edge of the crust cutter member may be sharpened. The crust cutter member may extend in a plane substantially parallel to a centerline of the handle.

The pizza cutter may also include a second crust cutter member coupled to the end of the handle and extending in a different direction therefrom. The second crust cutter member may also have sharpened edge. The second crust cutter may extend in a perpendicular direction relative to the crust cutter member above, in a plane that may be substantially parallel to the centerline of the handle. The pizza cutter may also include a blade cover for covering the circular blade and a threaded knob for securing the circular blade to the arm of the pizza cutter. The threaded knob may include gripping portions that may enable a user to remove the threaded knob by hand.

### DESCRIPTION OF THE DRAWINGS

FIG. 1 is a perspective view of a pizza cutter in accordance with a first embodiment of the invention;

FIG. 2 is an exploded view of the pizza cutter of FIG. 1;

FIG. 3 provides top, side and front views of the pizza cutter;

FIG. 4 is a perspective view of the threaded stud;

FIG. 5 provides top, side and front view of the blade;

FIG. 6 provides top, side and front view of knob;

FIG. 7 provides top, side and front view of the blade cover;

FIG. 8 provides top and side views of a pizza cutter in accordance with a second embodiment of the invention;

FIG. 9 illustrates cutting a pizza in a raised-edge pizza pan utilizing the pizza cutter shown in FIG. 3;

FIG. 10 illustrates cutting a pizza in a raised-edge pizza pan utilizing the second embodiment of the pizza cutter shown in FIG. 8;

FIG. 11 illustrates cutting a pizza in a raised-edge pizza pan utilizing a prior art pizza cutter.

### DETAILED DESCRIPTION OF THE PRESENTLY PREFERRED EMBODIMENTS

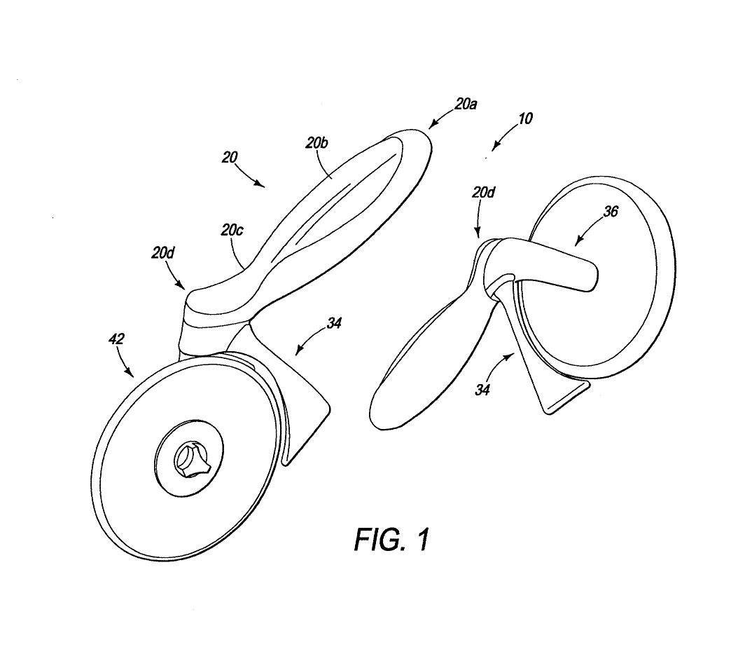

FIG. 1 is a perspective view of a first embodiment of a pizza cutter. Generally, the pizza cutter includes a handle 20, an arm 36, a circular blade 42 and a crust cutter 34.

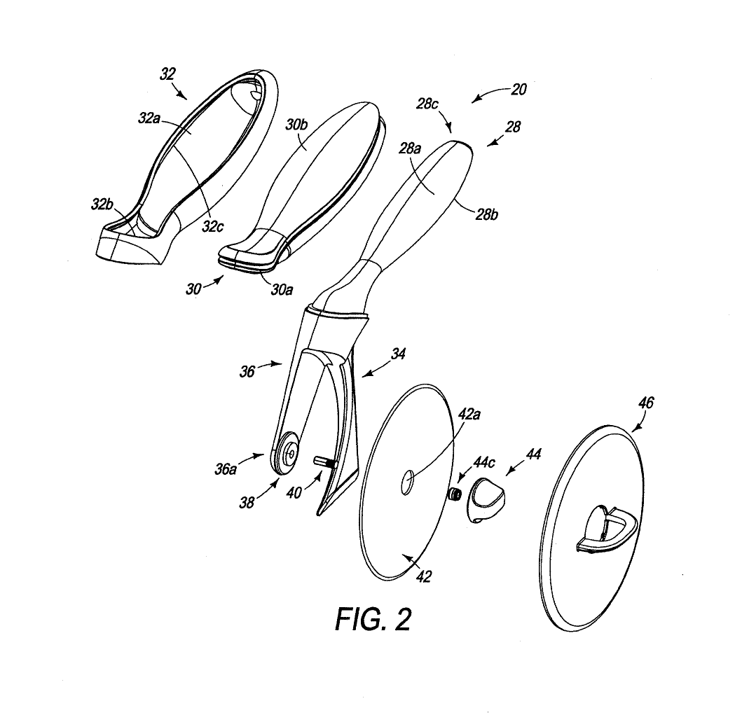

As shown in FIG. 2, the handle 20 may be comprised of an inner handle portion 28, an upper gripping portion 20, and a lower gripping portion 32. The upper gripping portion 20 and lower gripping portion 32 encase the inner handle portion 28. The top side of the lower gripping portion 32 may be substantially open and the bottom side may be substantially closed. The contour of the inner surface of the lower gripping portion 32a may be designed to match the contour of the lower surface of the inner handle portion 28b. The proximal end of the lower gripping portion may comprise an opening 32b, which may enable sliding the lower gripping portion 32 over the distal end of the inner handle portion 28c. A generally convex inner snapping surface 32c may be provided. The generally convex inner snapping surface 32c may be located on the inner surface of the lower gripping portion 32a, adjacent to the top side, and extending around the perimeter of the inner surface of the lower gripping portion 32a.

The lower side of the upper gripping portion (not shown) may be substantially open and the top side of the upper gripping portion 30b may be substantially closed. The contour of the inner surface of the upper gripping portion (not shown) may be designed to match the contour of the upper surface of the inner handle portion 28a. A generally concave inner snapping surface 30a may be provided. The generally concave inner snapping surface 30a may extend around the perimeter of the upper gripping portion 30.

The handle may be assembled by sliding the lower gripping portion 32 over the inner handle portion 28 via the opening at the proximal end of the lower gripping portion 32b. Next, the upper gripping portion 30 may be placed over the inner handle portion 28 and secured to the lower gripping portion 32 by pressing the respective snapping surfaces of the upper and lower gripping portions 30a, 32c together. It is to be understood that the upper and lower gripping portions 30, 32 may be assembled through other means. For example, the upper and lower gripping portions may be glued together. Other means for bonding materials, commonly known to those of skill in the art, may be utilized as well.

When assembled, the distal end of the handle 20a may be rounded to provide a more pleasing and ergonomic shape, as shown in FIG. 1. A generally bulbous gripping region 20b and tapered region 20c may be provided between the distal and proximal ends of the handle 20a, 20d, the tapered region 20c being near the proximal end 20d. It is to be understood that the handle 20 may be formed from fewer or more elements. For example, labels and the like may be embedded into the handle 20 or additional gripping features may be added. Alternatively, the handle 20 may not include gripping portions and may merely consist of a single material, such as plastic, wood or metal. Other configurations of the handle 20, commonly known to those of skill in the art, may be utilized as well.

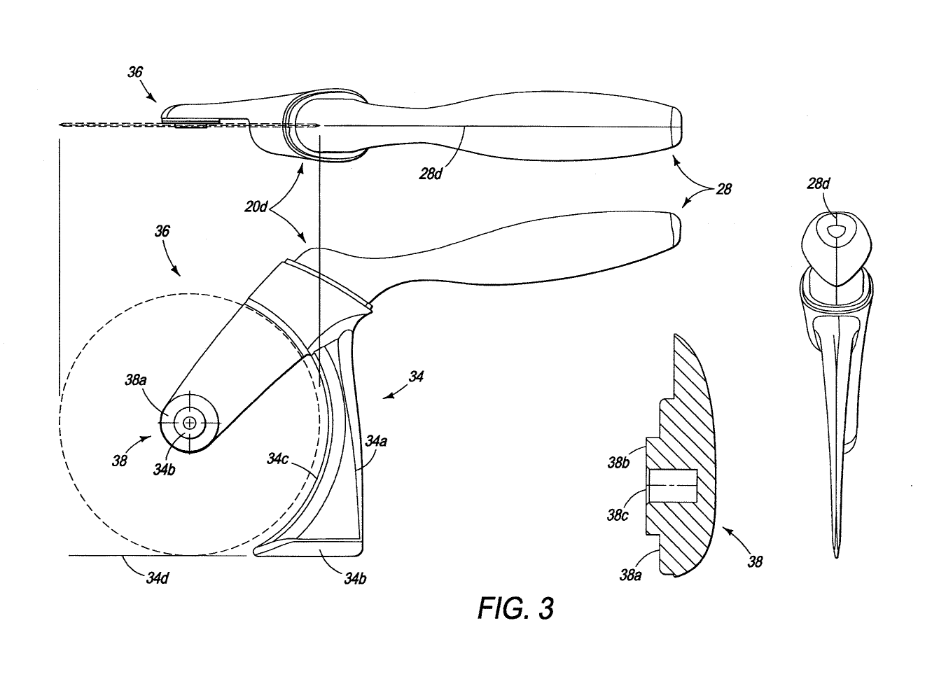

The arm 36 may extend from the proximal end of the handle 20d as shown in FIG. 1. As shown in FIG. 3, the arm 36 may extend in a plane that may be offset from the center line of the handle 28d. This allows the circular blade 42 coupled to the arm 36 to be centered under the center line of the handle 28d and may result in more stable operation of the pizza cutter 10.

The circular blade 42 may be mounted on the arm 36a by conventional means or in the manner of the first embodiment described herein. A bearing surface 38 for the circular blade 42 may be positioned at the distal end of the arm 36a, as shown in FIG. 2. As shown in FIG. 3, the bearing surface 38 may comprise first and second circular concentric surfaces 38a, 38b. The diameter of the second surface 38b may be roughly equivalent to an opening in the center 42a of the circular blade so that the circular blade 42 may be placed over the second surface 38b. The second surface 38b may be offset from the first surface 38a by an amount such that when the circular blade 42 is mounted on the bearing surface 38, the second surface 38b protrudes through the circular blade 42. The second surface 38b further comprises a bore 38c in the center for inserting a threaded stud 40, as shown in FIG. 2

As shown in FIG. 4, the threaded stud 40 has a generally cylindrical shape with a threaded first portion 40a and a second portion comprising compressible ribs 40b. The threaded stud 40 may be inserted into the bore of the second surface of the bearing surface 38c by pressing the second portion of the threaded stud 40b into the bore hole of the bearing surface 38c. The diameter of the second portion of the threaded stud 40b may be such that nominal pressing force may be required to press the threaded stud 40 into the bearing surface 38. For example, a press may be utilized to press the threaded stud 40 in the bore 38c.

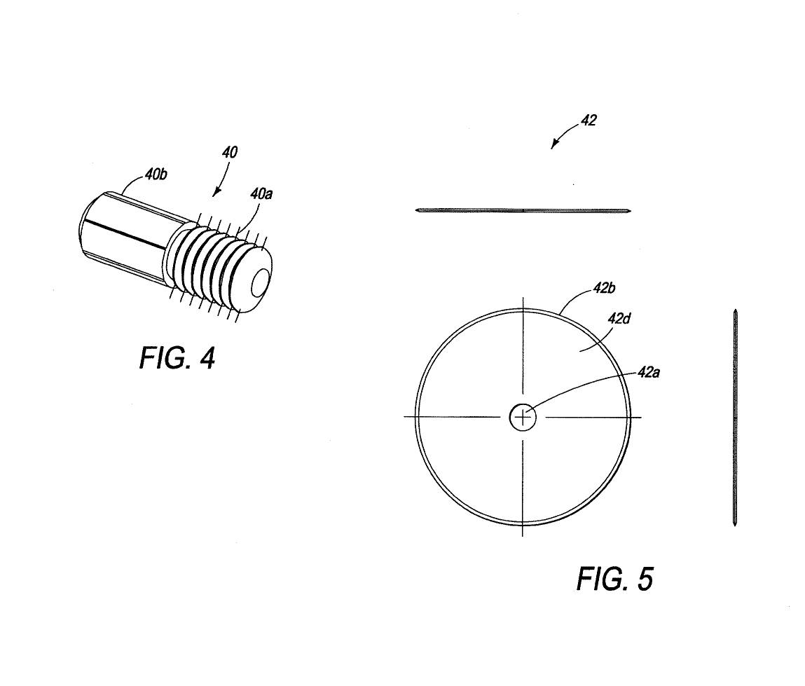

As shown in FIG. 5, the circular blade 42 may have a circular shape. A continuous sharpened edge 42b may be provided along the perimeter of the circular blade 42. Other configurations, such as serrations may be provided. The circular blade 42 may further comprise a concentric opening in the center of the circular blade 42a. The circular blade 42 may be secured to the arm 36 by slipping the circular blade 42 over the threaded stud 40 and onto the bearing surface 38. The circular blade 42 may be secured to the bearing surface 38 by threading a knob 44 on the threaded portion of the threaded stud 40a.

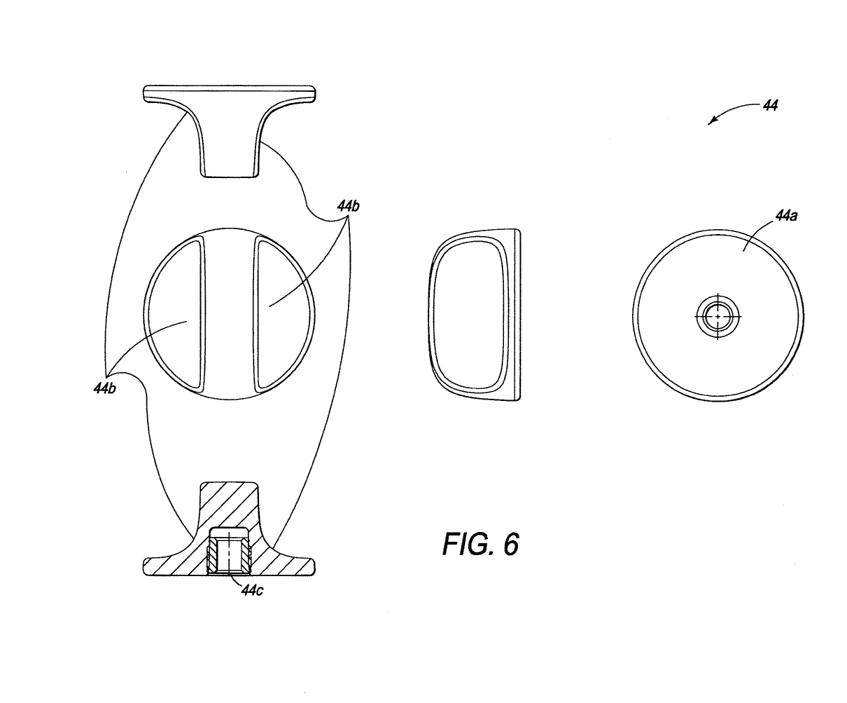

As shown in FIG. 6, the knob 44 may comprise a contact surface 44a and gripping surface 44b. The contact surface of the knob 44a may be circular with an outer diameter larger than the concentric opening in the center of the circular blade 42a, so as to secure the circular blade 42 to the arm 36. The center of the contact surface of the knob may comprise a threaded nut 44c. The threads of the threaded nut 44c may be designed to match the threads on the threaded portion of the threaded stud 40a. When fastened, the contact surface of the knob 44a may rest against the second surface of the bearing surface 38b thus allowing the circular blade 42 to rotate freely.

In operation, a user may remove the circular blade 42 by first unscrewing the knob 44 via the gripping surface of the knob 44b and then remove the circular blade 42 off of the bearing surface 38. This method of operation may facilitate cleaning the blade 42. It is to be understood that other methods may be utilized to secure the pizza cutter circular blade 42 to the arm 36. For example, a cotter pin assembly may be utilized instead of the threaded stud 40 and knob 44. Alternatively, a threaded surface may be provided within the bearing surface 38 and a screw may be screwed through the circular blade 42 to secure the circular blade 42 to the arm 36. Other methods, commonly known to those of skill in the art, may also be utilized to secure the circular blade 42 to the arm 36.

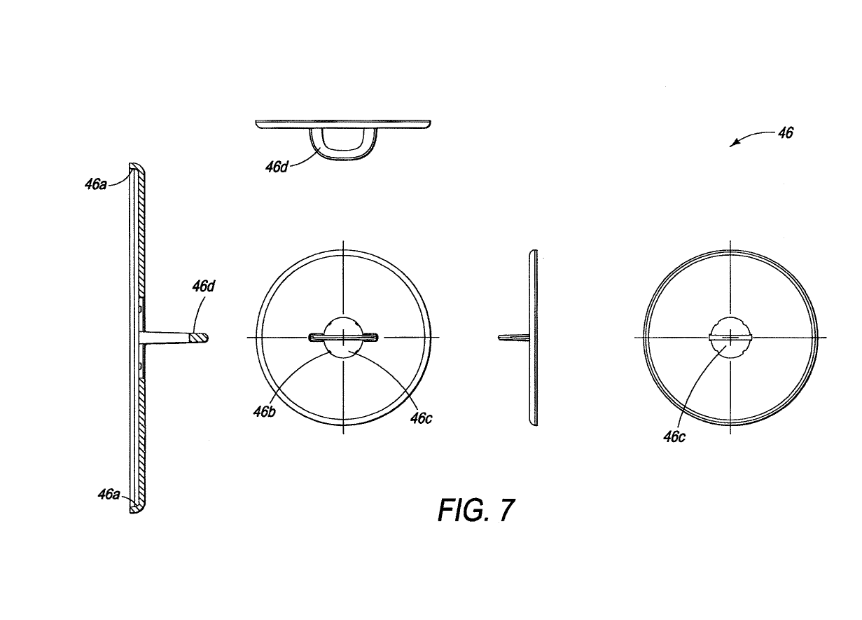

As shown in FIG. 7, a blade cover 46 may be provided for protecting the circular blade 42 when the pizza cutter 10 is not in use. The blade cover 46 may have a circular shape with an outer diameter slightly larger than the circular blade 42. A generally continuous curved surface 46a may be provided around the perimeter of the blade cover 46 to enable covering the edge of the circular blade 42b. A circular opening 46c may be provided at the center of the blade cover 46 to allow the knob 44 to protrude through the blade cover 46 when the blade cover 46 is on the circular blade 42. The diameter of the opening at the center of the blade cover 46c may be roughly equivalent to the diameter of the knob 44. Snapping members 46b may be provided along the perimeter of the opening at the center of the blade cover 46c for securing the blade cover 46 to the circular blade 42. A handle 46d positioned around the opening at the center of the blade cover 46c may be provided for removing the blade cover 46 from the circular blade 42. In operation, the snapping members 46b may snap to a gap region (not shown) between the contact surface of the knob 44a and the circular blade surface 42d, thus securing the blade cover 46 to the circular blade 42. In the alternative, the opening 46c may be modified to firmly and removably grasp the knob 44 to secure the cover 46 to the blade 42.

As shown in FIG. 3, the crust cutter 34 may extend in a downward direction away from the proximal end of the handle 20d. The perimeter of the crust cutter 34 may be comprised of an inner portion 34c, a lower cutting edge 34b, and a back portion 34a. The lower cutting edge of the crust cutter 34b extends in the same plane as the circular blade 42. The inner portion of the crust cutter 34c may be defined by a circle that may be concentric with the circular blade 42 and may have a diameter slightly larger than the circular blade 42 so as to not interfere with the operation of the circular blade 42. The distance between the lower cutting edge of the crust cutter 34b and the proximal end of the handle 20d may be approximately equal to the diameter of the circular blade 42. The lower cutting edge of the crust cutter 34b may be sharpened to enable cutting through the crust of a pizza and may extend tangentially with respect to the edge of the circular blade 42b.

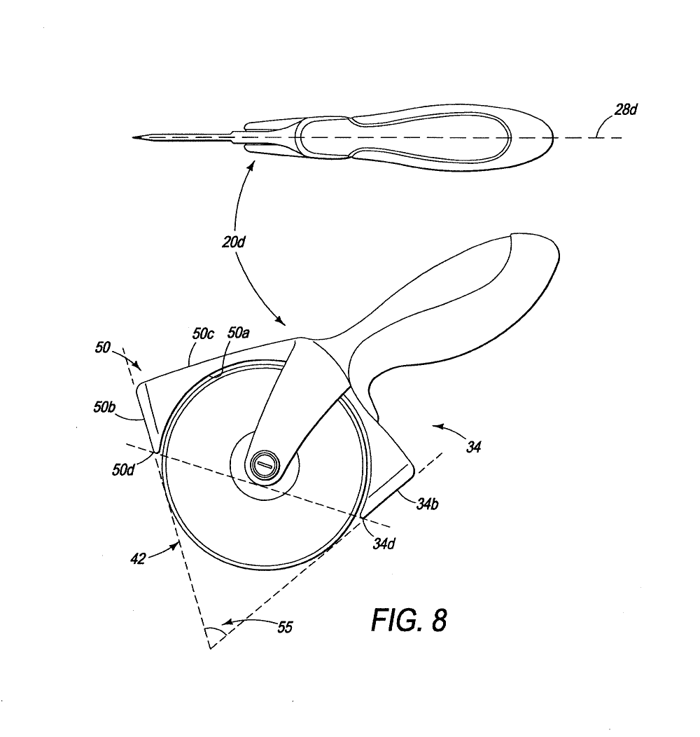

As shown in FIG. 8, a second embodiment comprises a second crust cutter 50 extending away from the proximal end of the handle 20d. The perimeter of the second crust cutter 50 may be comprised of an inner portion 50a, a front cutting edge 50b and a top portion 50c. The front cutting edge of the second crust cutter 50b may extend in the same plane as the circular blade 42. The inner portion 50a may be defined by a circle that may be concentric with the circular blade 42 and may have a diameter slightly larger than the circular blade 42 so that the second crust cutter 50 may not interfere with the operation of the circular blade 42. The distance between the front cutting edge of the second crust cutter 50b and the proximal end of the handle 20d may be approximately equal to the diameter of the circular blade 42. The front edge of the second crust cutter 50b may be sharpened to enable cutting through the crust of a pizza and may extend tangentially with respect to the edge of the circular blade 42b. The tip of the front cutting edge 50d and the tip of the lower cutting edge 34d may be position to maximize the cutting depth of the circular blade 42. In this regard, the angle 55 formed between the lower cutting edge of the crust cutter 34b and the front cutting edge of the second crust cutter 50b may be less than 90 degrees.

In some embodiments, the inner handle portion 28, the arm 36, and the crust cutter 34 may be formed from a single casting. For example, the handle, arm, and crust cutter may be formed from a single cast piece of aluminum. It is to be understood that other materials, such as stainless steel or a high strength polycarbonate plastic may be utilized as well. In addition, the inner handle portion 28, the arm 36, and the crust cutter 34 may be assembled through other techniques well known to those of ordinary skill in the art, such as utilizing an epoxy to bond the members together or providing threaded portions at the coupling sections of the members to thread the portions together.

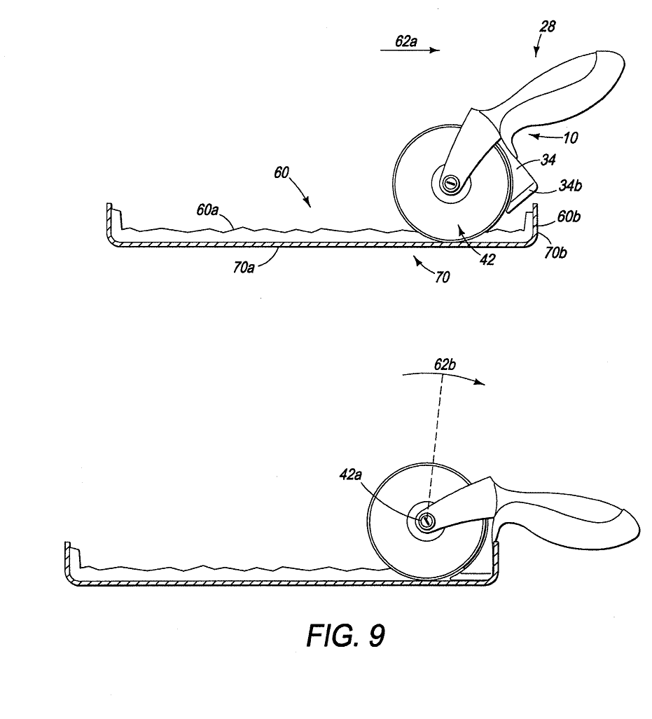

FIG. 9 illustrates cutting a pizza 60 in a raised-edge pizza pan 70 utilizing the pizza cutter shown in FIG. 3. In operation, the circular blade 42 of the pizza cutter 10 may be pressed through a center portion of a pizza 60a until the circular blade 42 comes into contact with the bottom portion of the pan 70a. The pizza cutter 10 may then be rolled in a direction 62a towards the crust wall 60b adjacent to the wall of the pan 70b. The pizza cutter 10 may then be positioned so that the lower cutting edge of the crust cutter 34b may be on top of the crust wall 60b and adjacent to the wall of the pan 70b. A pivotable downward force 62b with a center of rotation around the center of the blade 42a may then be applied through the handle of the pizza cutter 20 to push the lower cutting edge of the crust cutter 34b down through the crust wall 60b until the lower cutting edge of the crust cutter 34b comes into contact with the raised-edge pizza pan 70.

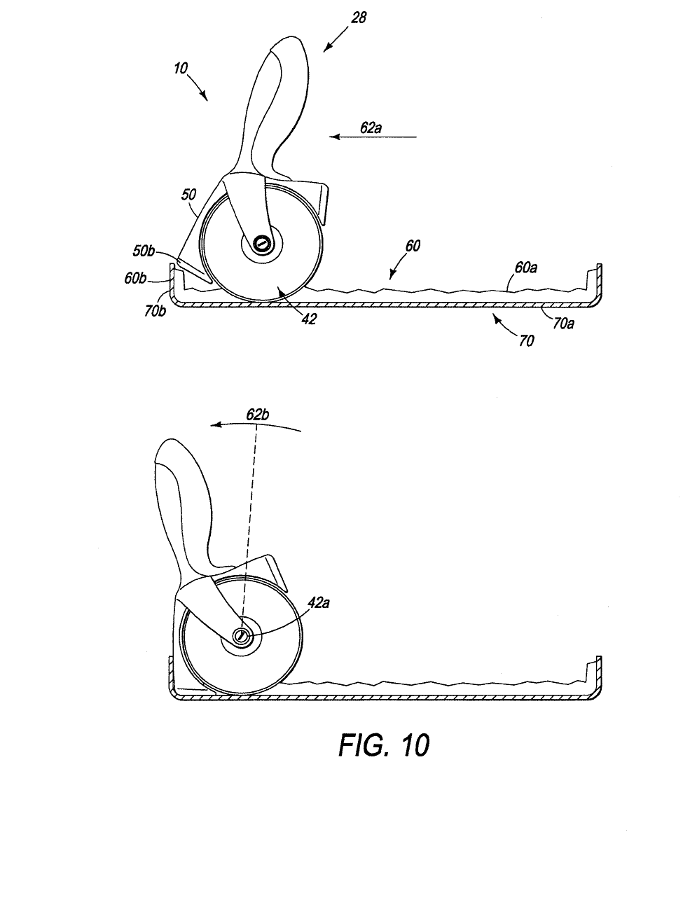

FIG. 10 illustrates cutting a pizza 60 in a raised-edge pizza pan 70 utilizing the second embodiment of the pizza cutter shown in FIG. 8. In operation, the circular blade 42 of the pizza cutter 10 may be pressed through a center portion of a pizza 60a until the circular blade 42 comes into contact with the bottom portion of the pan 70a. The pizza cutter 10 may then be rolled in a direction 62a towards the crust wall 60b adjacent to the wall of the pan 70b. The pizza cutter 10 may then be positioned so that the front cutting edge of the crust cutter 50b may be on top of the crust wall 60b and adjacent to the wall of the pan 70b. A pivotable downward force 62b with a center of rotation around the center of the blade 42a may then be applied through the handle of the pizza cutter 20 to push the front cutting edge of the crust cutter 50b down through the crust wall 60b until the front cutting edge of the crust cutter 50b comes into contact with the raised-edge pizza pan 70.

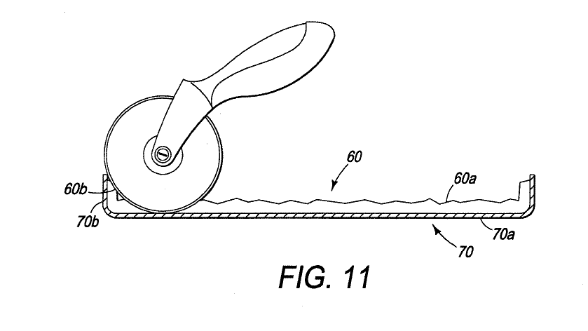

As can be appreciated from the descriptions above, the present embodiments overcome the problems associated with prior art pizza cutters, as shown in FIG. 11. In particular the crust cutters enable completely cutting the crust wall 60b of a pizza 60 in a raised-edge pizza pan 70.

Any other undisclosed or incidental details of the construction or composition of the various elements of the disclosed embodiment of the present invention or methods of their use are not believed to be critical to the achievement of the advantages of the present invention, so long as the elements possess the attributes needed for them to perform as disclosed. The selection of these and other details of construction are believed to be well within the ability of one of even rudimentary skills in this area, in view of the present disclosure. Illustrative embodiments of the present invention have been described in considerable detail for the purpose of disclosing a practical, operative structure whereby the invention may be practiced advantageously. The designs and methods described herein are intended to be exemplary only. The novel characteristics of the invention may be incorporated in other structural forms without departing from the spirit and scope of the invention. The invention encompasses embodiments both comprising and consisting of the elements and steps described with reference to the illustrative embodiments. All technical terms shall take on their customary meaning as established by the appropriate technical discipline utilized by those normally skilled in that particular art area. It is therefore intended that the foregoing detailed description be regarded as illustrative rather than limiting. It should be understood that the following claims, including all equivalents, are intended to define the spirit and scope of this invention.

What is claimed is:

1. A rotary cutter comprising:
a handle;
an arm extending from an end of the handle;
a circular blade coupled to the arm; and
a crust cutter member extending from the end of the handle, wherein an edge of the crust cutter member is sharpened and the crust cutter member extends in a plane that is substantially parallel to a centerline of the handle.

2. The rotary cutter according to claim 1, further comprising:
a second crust cutter member extending from the end of the handle, wherein an edge of the second crust cutter member is sharpened and the crust cutter member extends in a perpendicular direction relative to the handle, in a plane that is substantially parallel to a centerline of the handle.

3. The rotary cutter according to claim 1, further comprising:
a blade cover for covering the circular blade of the pizza cutter.

4. The rotary cutter according to claim 1, further comprising:
a threaded knob for securing the circular blade to the arm of the pizza cutter.

5. The rotary cutter according to claim 4, wherein the threaded knob further comprises a gripping portion to enable a user to remove the threaded knob by hand.

6. The rotary cutter according to claim 1, wherein the handle further comprises a gripping material.

7. The rotary cutter according to claim 6, wherein the gripping material is made from at least one of: abs plastic and rubber.

8. A rotary cutter comprising:
a handle;
an arm extending from an end of the handle;
a circular blade coupled to the arm; and
a crust cutter member extending from the end of the handle, at least a portion of a lower edge of the crust cutter member forms a cutting edge, the cutting edge extending substantially within a plane of the circular blade and at least a portion of the cutting edge extends in a direction that is tangent to an edge of the circular blade.

9. The rotary cutter according to claim 8, wherein the crust cutter member further comprises an inner circular portion.

10. The rotary cutter according to claim 9, wherein the inner circular portion is defined by a circle that is concentric with the circular blade.

11. The rotary cutter according to claim 8, wherein the handle, arm, and crust cutter member are formed from a single casting.

12. The rotary cutter according to claim 11, wherein the single casting is made of at least one of: aluminum, steel, and a high strength polycarbonate plastic.

13. The rotary cutter according to claim 8, further comprising
a second crust cutter member extending from the end of the handle, at least a portion of a lower edge of the second crust cutter member forms a cutting edge, the cutting edge of the second crust cutter member extending substantially within the plane of the circular blade and at least a portion of the cutting edge of the second crust cutter member extends in a direction that is tangent to the edge of the circular blade, where an angle formed between the at least a portion of the cutting edge of the first crust cutter member and the at least a portion of the cutting edge of the second crust cutter member is less than 90 degrees.

14. The rotary cutter according to claim 13, wherein the crust cutter member and the second crust cutter member further comprise inner circular portions.

15. The rotary cutter according to claim 14, wherein the inner circular portions are defined by a circle that is concentric with the circular blade.

16. The rotary cutter according to claim 13, further comprising first and second ends of the crust cutter member and second crust cutter member respectively, the first and second ends being positioned so as to enable maximizing a cutting depth capability of the circular blade.

17. The rotary cutter according to claim 13, wherein the handle, arm, crust cutter member and second crust cutter member are formed from a single casting.

18. The rotary cutter according to claim 17, wherein the single casting a made of at least one of: aluminum, steel, and a high strength polycarbonate plastic.

19. A method for cutting a pizza in a pizza pan, the method comprising:
providing a rotary cutter having a circular blade, handle, and crust cutter member;
pressing the circular blade of the rotary cutter through a bottom portion of the pizza until the circular blade comes in contact with a lower surface of the pizza pan;
positioning a bottom edge of the crust cutter member of the rotary cutter over a top edge of a wall portion of the crust of the pizza adjacent an upright wall of the pizza pan; and
pressing the crust cutter member down through the crust wall portion of the crust to cut the wall portion of the crust.

20. The method according to claim 19, wherein pressing comprises rotating the crust cutter member around a center of the circular blade until a lower edge of the crust cutter member comes in contact with the lower surface of the pizza pan.
